(19) United States
(12) Patent Application Publication
(10) Pub. No.: US 2020/0057815 A1
(43) Pub. Date: Feb. 20, 2020

(54) IMAGE-BASED ITEM IDENTIFYING SYSTEM AND METHOD

(71) Applicant: Randy James Powers, Mission BC (CA)

(72) Inventor: Randy James Powers, Mission BC (CA)

(21) Appl. No.: 16/122,636

(22) Filed: Sep. 5, 2018

(30) Foreign Application Priority Data
Aug. 17, 2018 (CA) 3014980

(51) Int. Cl. G06F 17/30; G06K 9/00

(52) U.S. Cl. CPC G06F 17/30256; G06K 9/22; G06F 17/30867; G06K 9/00255

(57) ABSTRACT

An image-based item identifying system and method including a mobile device hosting an application software in communication with a server via a communication network and a database on the server. The mobile device having a built-in camera is configured to capture a digital image of an object. The digital image of the object is submitted or uploaded to a search engine on the server to be analyzed. The application software then analyzes and matches the object included in the digital image with a stored object identifier of the object. Information regarding a captured the object is transmitted to a user and displayed on a display of the mobile device. The system allows a user to identify an object in real-time and learn about the object.

### BACKGROUND OF THE INVENTION

The attached application claims benefit under 35 USC 119 to Canada National Application No. 3,014,980 filed on Aug. 17, 2018, the disclosure of which is incorporated herein by reference in its entirety. The following application includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of software of existing art and more specifically relates to a mobile application.

### RELATED ART

A mobile app is a computer program designed to run on a mobile device such as a phone/tablet or watch. The term “app”, which is short for “software application”, has become very popular. Usage of mobile apps has become increasingly prevalent across mobile phone users. Mobile apps were originally offered for general productivity and information retrieval, including email, calendar, contacts, the stock market and weather information. However, public demand and the availability of developer tools drove rapid expansion into other categories. Mobile phones having a camera are proliferating at a rapid pace. Driven through the low cost of cameras, the percentage of camera phones of all mobile phones is rapidly increasing as well. Accordingly, there exists a need for more effective use of the facilities provided by a mobile camera phone.

U.S. Pat. No. 7,565,139 to Hartmut Neven, Sr. relates to an image-based search engine for mobile phones with camera. The described image-based search engine for mobile phones with camera includes an image-based information retrieval system is disclosed that includes a mobile telephone and a remote server. The mobile telephone has a built-in camera and a communication link for transmitting an image from the built-in camera to the remote server. The remote server has an optical character recognition engine for generating a first confidence value based on an image from the mobile telephone, an object recognition engine for generating a second confidence value based on an image from the mobile telephone, a face recognition engine for generating a third confidence value based on an image from the mobile telephone, and an integrator module for receiving the first, second, and third confidence values and generating a recognition output.

### SUMMARY OF THE INVENTION

In view of the foregoing disadvantages inherent in the known software art, the present disclosure provides a novel image-based item identifying system. The general purpose of the present disclosure, which will be described subsequently in greater detail, is to provide a mobile app that allows a user to take a photo of an item and receive information on the object.

An image-based item identifying system is disclosed herein. The image-based item identifying system includes a mobile device hosting an application software in communication with a server via a communication network and a database on the server. The mobile device having a built-in camera is configured to capture a digital image of an object. The database stores object identifiers and information on a plurality of the objects. The digital image of the object is submitted or uploaded to a search engine on the server to be analyzed. A user may use a previously taken photo stored on the mobile device or take a new image of an object. The application software then uses object recognition to analyze and match the object included in the digital image with a stored object identifier of the object. Information regarding a captured the object is transmitted to a user and displayed on a display of the mobile device. The system allows a user to identify an object in real-time and learn about the object. The application software may use an internet connection to connect with the server and database to identify the objects. In certain embodiments the ability to take an image of multiple objects may be offered, this will have the capability to identify the separate objects in the image, and present it to the user to select the object the user wishes to get information about.

According to another embodiment, a method of identifying objects using the image-based item identifying system is also disclosed herein. The method of identifying objects using the image-based item identifying system includes providing an image-based item identifying system; capturing a digital image of an object using a mobile device such as a smartphone having a built-in camera; uploading the digital image of an object using the mobile device; analyzing and comparing the object included in the digital image with a stored object identifier on the database; recognizing the object using the object identifiers and object recognition; transmitting information regarding the object to a user and displaying the information on a display of the mobile device. The object recognition may include optical character recognition, facial recognition, rigid texture object recognition, and articulate object recognition, singly or in combination. The digital image is submitted as a query to a search engine configured to search the database. In a preferred embodiment, the information provided is background-information and inventor-information regarding the object.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an image-based item identifying system, constructed and operative according to the teachings of the present disclosure.

FIG. 1 is a perspective view of the image-based item identifying system during an ‘in-use’ condition, according to an embodiment of the disclosure.

FIG. 2 is a diagram illustrating a method of identifying objects using the image-based item identifying system, according to an embodiment of the present disclosure.

FIG. 3 is a screen view of the image-based item identifying system, according to an embodiment of the present disclosure.

FIG. 4 is a flow diagram illustrating a method of identifying objects using the image-based item identifying system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a software application and more particularly to an image-based item identifying system as used to improve the use of a camera on a mobile device to identify objects in real time.

Generally, the image-based item identifying system allows a user to identify objects and learn about the objects using a mobile application of the present invention. The user may take a photo using a smart phone or other mobile device and upload it to the application hosted on the mobile device. The photo is then analyzed using software and matched with information on the object. The information provided on the object may include who the inventor of the object is and background and history information. Photos of objects, living and non-living, may be uploaded and analyzed using the software of the present invention.

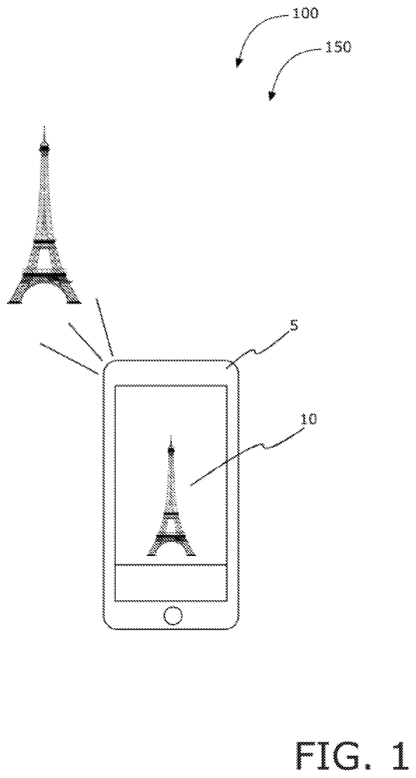

Referring now more specifically to the drawings by numerals of reference, there is shown in FIGS. 1-3, various views of an image-based item identifying system 100. FIG. 1 shows the image-based item identifying system 100 during an ‘in-use’ condition 150, according to an embodiment of the present disclosure. Here, the image-based item identifying system 100 may be beneficial for use by a user to identify objects in real-time. As illustrated, the image-based item identifying system 100 may include a mobile device 5 hosting an application software in communication with a server via a communication network and a database on the server. The mobile device 5 having a built-in camera is configured to capture a digital image 10 of an object. The database stores object identifiers and information on a plurality of the objects. The digital image 10 of the object is submitted or uploaded to a search engine on the server to be analyzed. A user may use a previously taken photo stored on the mobile device 5 or take a new image of an object. The application software then uses object recognition to analyze and match the object included in the digital image 10 with a stored object identifier of the object. Information regarding a captured the object is transmitted to a user and displayed on a display of the mobile device 5 such as a smartphone, tablet, mobile phone, gaming device, mobile electronic messaging device, or a music player.

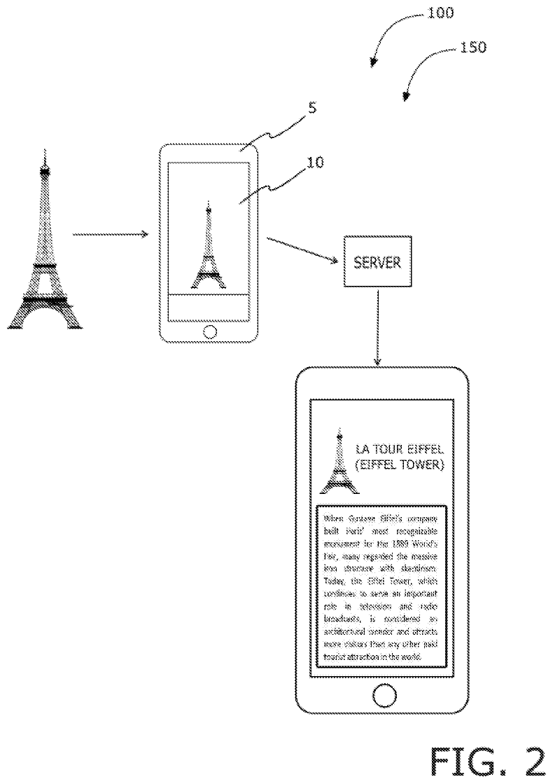

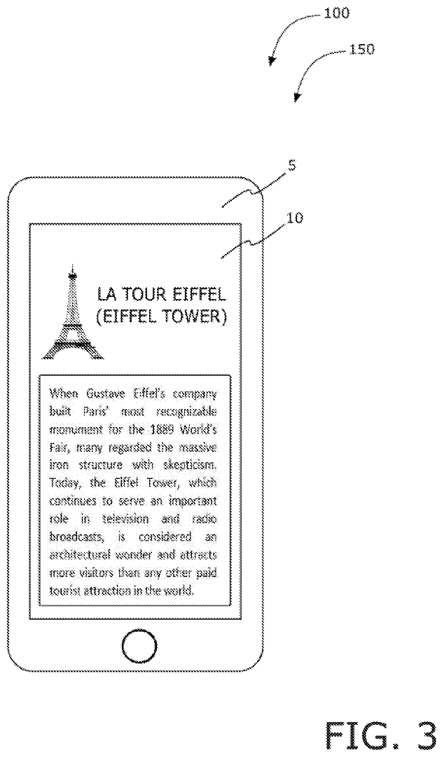

Referring now to FIGS. 2-3 showing various views of the image-based item identifying system 100 of FIG. 1, according to an embodiment of the present disclosure. The device allows a user to take an image of an item or invention using a mobile device 5 and receive detailed information on the item. The mobile device 5 includes an optical sensor configured to capture and generate a digital image 10, or photograph (static or non-static). The information transmitted to the user includes information relating to the object recognized such as inventor-information relating to the object, an item description, and background-information on the object to educate the user on demand. Further, the information may be provided to the user in a variety of user selected languages.

Once a user uploads the digital image 10 photograph, the software then uses object recognition to analyze and match the object included in the digital image with a stored object identifier of the object. Based on similarities identified between the digital image 10 photograph and information stored on the database, a match is confirmed. The object recognition may include optical character recognition, facial recognition, rigid texture object recognition, and articulate object recognition. The system may use optical character recognition, facial recognition, rigid texture object recognition, and articulate object recognition singly or in combination to correctly recognize inanimate the objects and animate the objects. Additionally, the system may identify and extract specific sections or elements from the image for analysis. Those with ordinary skill in the art will now appreciate that upon reading this specification and by their understanding the art of capturing objects and object recognition as described herein, methods of object recognition will be understood by those knowledgeable in such art.

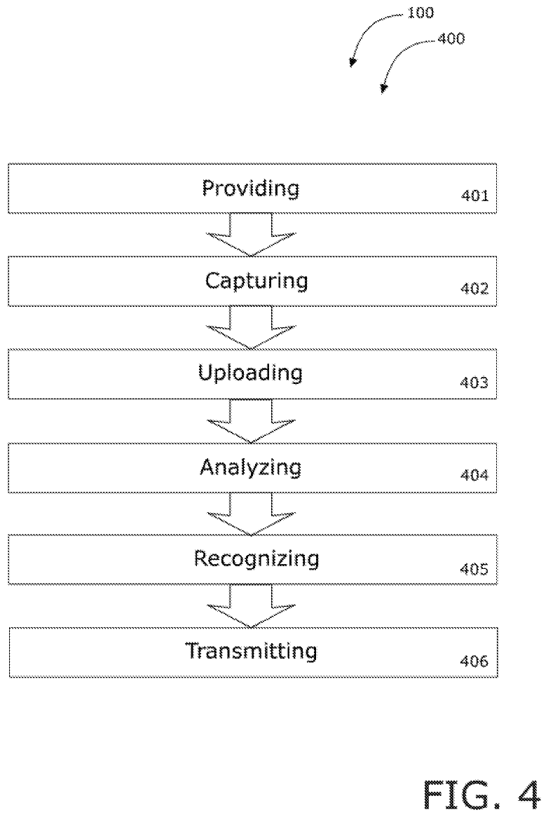

Referring now to FIG. 4 showing a flow diagram illustrating a method of identifying objects using the image-based item identifying system 400 according to an embodiment of the present disclosure. In particular, the method of use 400 may include one or more components or features of the image-based item identifying system 100 as described above. As illustrated, the method of identifying objects using the image-based item identifying system 400 may include the steps of: step one 401, providing an image-based item identifying system; step two 402, capturing a digital image 10 of an object using a mobile device 5 having a built-in camera; step three 403, uploading the digital image 10 of an object using the mobile device 5; step four 404, analyzing and comparing the object included in the digital image 10 with a stored object identifier on the database; step five 405, recognizing the object using the object identifiers and object recognition; and step six 406, transmitting information regarding the object to a user and displaying the information on a display of the mobile device 5.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of identifying objects using the image-based item identifying system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by letters patent is set forth in the appended claims:

1. An image-based item identifying system comprising:
a mobile device hosting an application software in communication with a server via a communication network;
a database on said server;
wherein said mobile device having a built-in camera is configured to capture a digital image of an object;
wherein said database stores object identifiers and information on a plurality of said objects;
wherein said digital image of said object is uploaded to said server;
wherein said application software uses object recognition to analyze and match said object included in said digital image with a stored object identifier of said object; and
wherein information regarding a captured said object is transmitted to a user and displayed on a display of said mobile device.

2. The image-based item identifying system of claim 1, wherein said mobile device is selected from the group consisting of a smartphone, tablet, mobile phone, gaming device, mobile electronic messaging device, and a music player.

3. The image-based item identifying system of claim 2, wherein said mobile device includes an optical sensor configured to capture and generate said digital image.

4. The image-based item identifying system of claim 3, wherein said digital image is a photograph.

5. The image-based item identifying system of claim 4, wherein said digital image is static.

6. The image-based item identifying system of claim 1, wherein said information transmitted to said user includes information relating to said object recognized.

7. The image-based item identifying system of claim 6, wherein said information further includes inventor-information relating to said object.

8. The image-based item identifying system of claim 7, wherein said information further includes an item description of said object.

9. The image-based item identifying system of claim 8, wherein said information includes background-information on said object.

10. The image-based item identifying system of claim 1, wherein said information is provided to said user in a user selected language.

11. The image-based item identifying system of claim 1, wherein said object recognition is configured to recognize text.

12. The image-based item identifying system of claim 1, wherein said object recognition is configured to recognize faces using facial recognition.

13. The image-based item identifying system of claim 1, wherein said object recognition is configured to recognize inanimate said objects.

14. The image-based item identifying system of claim 1, wherein said object recognition is configured to recognize animate said objects.

15. An image-based item identifying system, the image-based item identifying system comprising:
a mobile device hosting an application software in communication with a server via a communication network;
a database on said server;
wherein said mobile device having a built-in camera is configured to capture a digital image of an object;
wherein said database stores object identifiers and information on a plurality of said objects;
wherein said digital image of said object is uploaded to said server;
wherein said application software uses object recognition to analyze and match said object included in said digital image with a stored object identifier of said object;
wherein information regarding a captured said object is transmitted to a user and displayed on a display of said mobile device;
wherein said mobile device includes an optical sensor configured to capture and generate said digital image;
wherein said digital image is a photograph;
wherein said digital image is static;
wherein said information transmitted to said user includes information relating to said object recognized;
wherein said information further includes inventor-information relating to said object;
wherein said information further includes an item description of said object;
wherein said information includes background-information on said object; and
wherein said information is provided to said user in a user selected language.

16. A method of identifying objects using the image-based item identifying system, the method comprising the steps of:
providing an image-based item identifying system;
capturing a digital image of an object using a mobile device having a built-in camera;
uploading said digital image of an object using said mobile device;
analyzing and comparing said object included in said digital image with a stored object identifier on said database;
recognizing said object using said object identifiers and object recognition;
transmitting information regarding said object to a user and displaying said information on a display of said mobile device.

17. The method of claim 16, wherein said object recognition includes optical character recognition, facial recognition, rigid texture object recognition, and articulate object recognition.

18. The method of claim 16, wherein said digital image is submitted as a query to a search engine configured to search said database.

19. The method of claim 16, wherein said information includes background-information and inventor-information regarding said object.

20. The method of claim 16, wherein said mobile device is selected from the group consisting of a smartphone, tablet, mobile phone, gaming device, mobile electronic messaging device, and a music player.
